(19) United States
(12) Patent Application Publication
(10) Pub. No.: US 2007/0297854 A1
(43) Pub. Date: Dec. 27, 2007

(54) Corner bracket

(76) Inventor: Rolf J. Ohrstrom, Toronto (CA)

Correspondence Address: Rolf J. Ohrstrom, 13 Snapdragon Drive, Toronto, ON, M2J 4X5, US

(21) Appl. No.: 11/455,835

(22) Filed: Jun. 20, 2006

(51) Int. Cl. E06B 3/984

(52) U.S. Cl. 403/401

(57) ABSTRACT

A corner bracket apparatus for a slidable frame includes a body having first and second arm portions depending therefrom, the first and second arm portions being oriented generally orthogonally relative to each other and adapted for insertion into respective first and second hollow framing members of said slidable frame, the first arm defining an outboard side edge and an inboard side edge generally opposite the outboard side edge and an internal pocket positioned therebewteen. The corner bracket apparatus further includes a lifter member pivotably coupled to the body and generally received in the pocket, the lifter member having a contact portion adapted to bear against a runner along which said slidable frame is adapted to slide, the lifter member being pivotable between an advanced position in which the contact portion is proud of the outboard side edge of the first arm, and a retracted position in which the contact portion is generally shy of the outboard side edge of the first arm.

### FIELD

The present invention relates to a corner bracket apparatus with integral lifter member for use in, for example sliding screen doors.

### BACKGROUND

Corner bracket apparatuses can be used in sliding frames, such as screen doors, to facilitate joining together the horizontal and vertical members of the frame, and to provide rollers on which the screen door frame can roll between open and closed positions.

U.S. Pat. No. 4,006,513 (Offterdinger) discloses a runner wheel support for sliding doors, windows and the like that consists of a support body which is a press fit in the respective frame, and which carries the support wheel or roller on an arm carried by a disengageable pivot. The wheel support arm has a cam member cooperating with a height adjustment screw and spring fingers on the support body to hold the wheel support in a stored position while the support body is fitted into a frame member, and thereafter to free the wheel support from this stored position and to hold it in an operative position. Preferably the support body is of L-shape and acts as a connector to join together mitre-cornered pieces of frame. Movement of the wheel support arm to a removal position disengages the cam member from the spring fingers, so that the arm can be disengaged from the pivot and removed. A spring is provided to urge the wheel support arm to the operative position, and the arm is provided with transversely-extending dimples that engage the bore side walls to centralize the wheel.

U.S. Pat. No. 4,030,160 (Lambertz et al.) discloses a combined corner bracket and door roller assembly for use in a sliding metal patio screen door. The corner bracket is provided with first pivot means about which a roller assembly pivots during adjustment and in use. The roller assembly comprises a housing, a roller, a second pivot means for mounting the roller in the housing and an elongated curved resilient arm connected to the housing which provides for resilient mounting and adjustment of the roller assembly. The second pivot means is positioned between the first pivot means and the extreme outer vertical edge of the door so that the roller is positioned much closer to the vertical edge than in the prior art. By this device the wheel base of the door is maximized, the door is always resiliently mounted on the track, and the problem of track jumping is minimized.

U.S. Pat. No. 4,873,741 (Riegelman) discloses a sliding door roller apparatus that includes a replaceable wheel assembly that can be easily removed and replaced on a holding member. The wheel assembly includes a resilient housing, a wheel, and an axle on which the wheel turns. The resilient housing has a pair of opposite facing sidewalls, each having an integral end portion that extends toward and overlaps the other. Each end portion includes at least one locking finger that is positionable within an opening on the holding member. The resiliency of the housing permits the locking fingers to be placed or removed from an opening located on the holding member. The apparatus also includes an adjustment mechanism that positions the wheel assembly outside the sliding door frame to permit the frame to be properly aligned within its door opening.

### SUMMARY

The present specification discloses, among other things, one or more novel corner bracket apparatuses and methods of making and using such corner bracket apparatuses.

According to one aspect, a corner bracket apparatus for a slidable frame includes a body having first and second arm portions depending therefrom, the first and second arm portions being oriented generally orthogonally relative to each other and adapted for insertion into respective first and second hollow framing members of said slidable frame, the first arm defining an outboard side edge and an inboard side edge generally opposite the outboard side edge and an internal pocket positioned therebewteen. The corner bracket apparatus further includes a lifter member pivotably coupled to the body and generally received in the pocket, the lifter member having a contact portion adapted to bear against a runner along which said slidable frame is adapted to slide; the lifter member-being pivotable between an advanced position in which the contact portion is proud of the outboard side edge of the first arm, and a retracted position in which the contact portion is generally shy of the outboard side edge of the first arm. The corner bracket apparatus further includes biasing means for urging the lifter member towards the advanced position.

The corner bracket apparatus can comprise an adjustment member for adjusting the retracted position of the lifter member relative to the body, the retracted position adjustable between a maximum retraction in which the contact portion is shy of the outboard side edge of the first arm, and a minimum retraction position in which the lifter member is disposed at least partially towards the advanced position. The adjustment member can comprise an elongate threaded element having an abutment end engaged by the lifter member when in the retracted position and an actuating end opposite the abutment end and accessible through the body by a second opening provided in a second sidewall of the housing.

The body can comprise a pivot boss, and the lifter member can comprise a pivot aperture for pivotal engagement with the pivot boss. The lifter member can comprise an attachment slot extending through the thickness of lifter member from an outer surface of the lifter member to the pivot aperture for removable snap-fit coupling between the pivot aperture of the lifter member and the pivot boss. The first opening can have a thickness that is greater than the thickness of the lifter member such that the lifter member can pass through the first opening for the removable snap-fit coupling between the pivot aperture of the lifter member and the pivot boss.

The pocket can be provided substantially in the first arm and can extend longitudinally between a proximate sidewall near the second arm and a distal sidewall spaced away from the second arm, and the pivot boss can be provided in the pocket adjacent the distal sidewall such that the contact portion is positioned longitudinally intermediate the pivot boss and the proximate sidewall.

The biasing means can comprise a leaf spring having a first leg bearing against an inner surface of the pocket and a second leg bearing against the lifter member. The contact portion can comprise a glider element. The glider element can comprise a convex surface that is stationary relative to the lifter member and adapted to bear against an upper surface of the-runner. The glider element can comprise retaining lugs on either side of the convex surface, the retaining lugs adapted to engage respective opposing side surfaces of the runner.

According to another aspect, a corner bracket apparatus for a slidable frame comprises a body having first and second arm portions depending therefrom, the first and second arm portions being oriented generally orthogonally relative to each other and adapted for insertion into respective first and second hollow framing members of said slidable frame, the first arm defining an outboard side edge and an inboard side edge generally opposite the outboard side edge and an internal pocket positioned therebewteen. The corner bracket apparatus further comprises a lifter member pivotably coupled to the body and generally received in the pocket, the lifter member having a contact portion adapted to bear against a runner along which said slidable frame is adapted to slide, the contact portion being fixed relative to the lifter member, the lifter member being pivotable between an advanced position in which the contact portion is proud of the outboard side edge of the first arm, and a retracted position in which the contact portion is generally shy of the outboard side edge of the first arm. The corner bracket further comprises biasing means for urging the lifter member towards the advanced position.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a front perspective view of an example of a corner bracket apparatus according to the present teaching in combination with a portion of a frame (shown in exploded view) with which the corner bracket can be used and track along which the frame can slide;

FIG. 2 is a front elevation view of an example of the frame of FIG. 1 with four corner brackets of FIG. 1;

FIG. 3 is an enlarged perspective view of the corner bracket of FIG. 1, with a lifter member thereof shown in an advanced position;

FIG. 4 is an enlarged perspective view of the corner bracket of FIG. 1, with a lifter member thereof shown in a retracted position;

FIG. 5 is an exploded perspective view of the corner bracket of FIG. 1;

FIG. 6 is a top view of a lifter member element of the corner bracket apparatus of FIG. 1;

FIG. 7 is an enlarged front perspective view of the corner bracket of FIG. 1, viewed from another angle, and including portions of the track of FIG. 1;

FIG. 8 is a rear perspective view of the corner bracket of FIG. 1; and

FIGS. 9 and 10 are front views of another example of a corner bracket apparatus according to the present teaching, showing a lifter member thereof in advanced and retracted positions, respectively.

### DETAILED DESCRIPTION

The following description includes examples of various methods, systems, apparatuses, or processes to illustrate aspects of the teaching disclosed herein. The examples described herein are illustrative and are not intended to limit the scope of any invention that is defined by one or more claims. The examples and embodiments described herein can be modified without departing from the scope of one or more inventions as defined by one or more claims. A single claimed invention can include features from one or more examples or embodiments, and the claimed inventions are not limited to examples or embodiments having all of the features of any one example or embodiment described herein, or having features common to multiple or all of the examples or embodiments described herein. The teaching herein may include particular subject matter that is beyond the scope of the claims appended hereto. The applicants, owners, or inventors retain all rights to such particular subject matter (including, for example, the right to file divisional or continuation applications related thereto) and do not merely by the absence of inclusion in claims appended hereto abandon, disclaim, or dedicate to the public any rights to such particular subject matter.

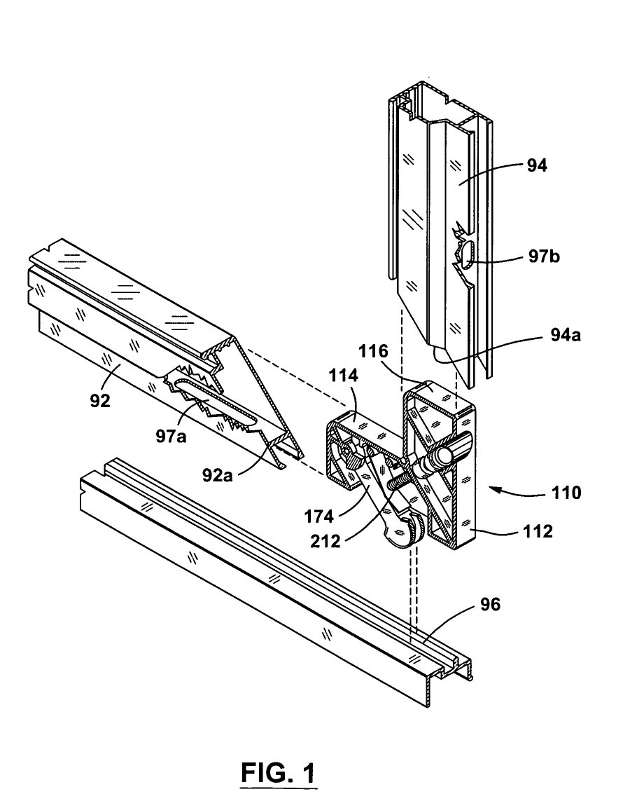

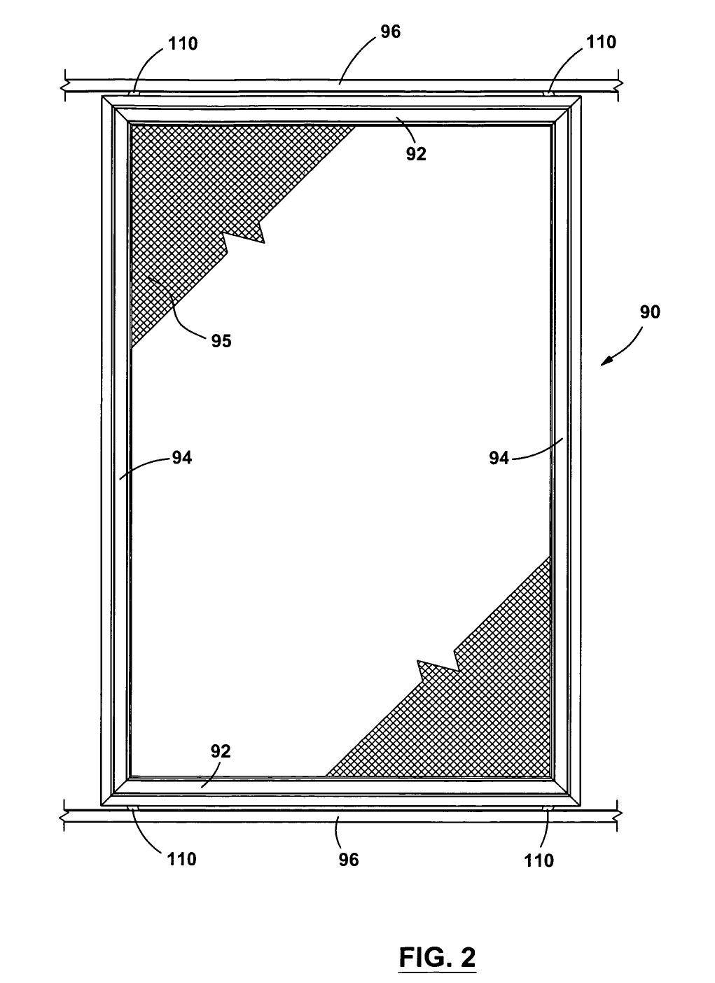

A corner bracket apparatus 110 in accordance with one example of the applicant's teaching can be seen in FIGS. 1 and 2. The corner bracket 110 is adapted for use with a slidable frame 90. In the example illustrated, the slidable frame 90 is in the form of a sliding patio screen door, having opposed horizontal and vertical framing members 92, 94, respectively connected at their ends to form a generally rectangular frame within which is mounted a screen sheet 95. In the example illustrated, the frame 90 contains four corner brackets 110, one at each corner. The frame 90 can be adapted to slide along opposed lower and upper horizontal track members (or runners) 96, the track members 96 being engaged by portions of the corner brackets 110, as described in further detail subsequently herein.

As can be seen in FIG. 1, the corner bracket 110 comprises a body 112 with a first arm portion 114 and a second arm portion 116 depending from the body 112. The first and second arm portions 114, 116 are, in the illustrated example, oriented generally perpendicular relative to each other and are adapted for insertion into respective first and second (i.e. horizontal and vertical) hollow framing members 92, 94 of the slidable frame 90. The corner bracket 110 can thus facilitate joining together the horizontal and vertical framing members 92, 94 to form the rectangular frame 90.

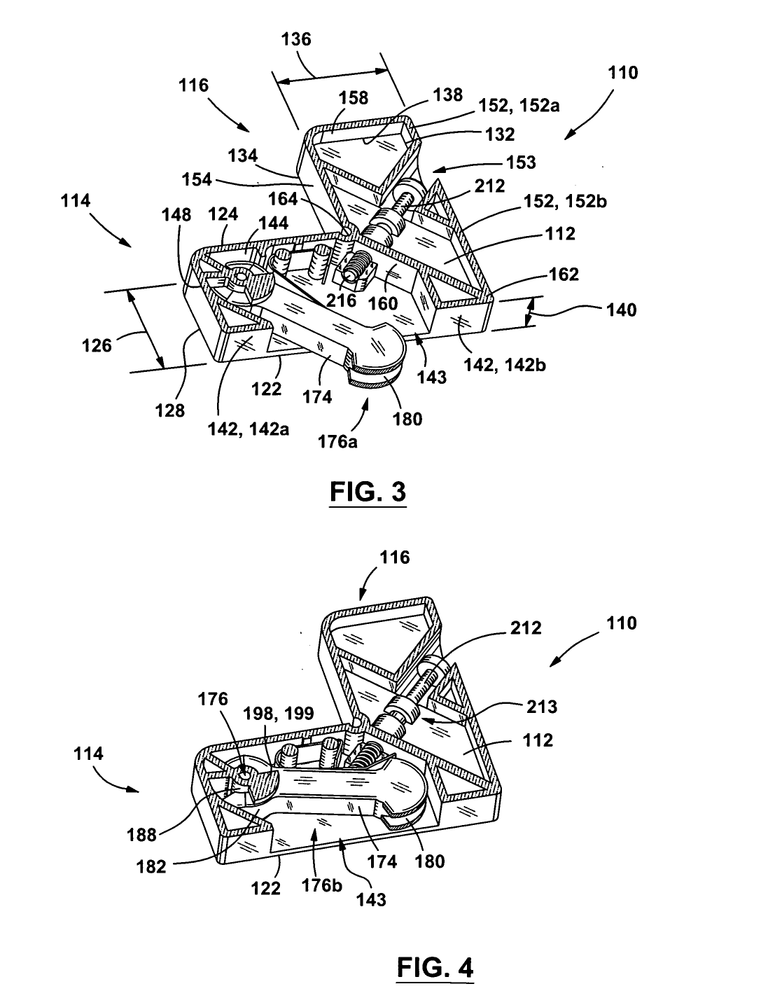

Referring now also to FIG. 3, the first arm portion 114 defines an outboard side edge 122 and an inboard side edge 124 generally opposite the outboard side edge 122. In the example illustrated, the outboard and inboard side edges 122, 124 extend generally horizontally in the installed position of the frame 90, and are vertically spaced apart to define the width 126 of the first arm portion 114. In the example illustrated, the width 126 generally corresponds to the vertical extent of the first arm portion 114, and is sized to provide a press-fit within the hollow first framing member 92. The first arm portion 114 also has an end edge 128 extending between the outboard and inboard side edges 122, 124, distal the second arm portion 116.

The second arm portion 116 defines an outboard side edge 132 and an inboard side edge 134 generally opposite the outboard side edge 132. In the example illustrated, the outboard and inboard side edges 132, 134 extend generally vertically in the installed position of the frame 90, and are horizontally spaced apart to define the width 136 of the first arm portion 114. In the example illustrated, the width 136 generally corresponds to the horizontal extent of the second arm portion 116, and is sized to provide a press-fit within the hollow second framing member 94. The second arm portion 116 also has an end edge 138 extending between the outboard and inboard side edges 132,134, distal the first arm portion 114.

The outboard and inboard side edges 122, 132 and 124, 134 can be, but need not be, continuous edges extending along the body 112 of the corner bracket 110. The edges 122, 132, 124, 134 can be discontinuous, and/or can be formed by lugs or bosses extending from the body 112. In the example illustrated, the outboard side edges 122, 132 are generally continuous and are, in use, positioned adjacent an outer periphery of the frame 90, and the inboard side edges 124, 134 are generally continuous and are, in use, positioned adjacent an inner periphery of the frame 90.

The body 112 can further define a thickness 140 that extends orthogonal to the arm portions 114, 116 (i.e. orthogonal to the plane of the frame 90). In the example illustrated, the thickness 140 is at least partially defined by upstanding walls of the body 112, including outboard and inboard sidewalls 142, 144, respectively, and an end wall 148 disposed adjacent the outboard and inboard side edges 122, 124 and the end edge 128, respectively, of the first arm portion 114. Similarly, the second arm portion 116 of the body is provided with outboard and inboard sidewalls 152, 154 and an end wall 158 disposed adjacent the outboard and inboard side edges 132, 134 and the end edge 138 thereof.

In the example illustrated, the outboard sidewall 142 of the first arm portion 114 comprises two spaced apart wall segments 142a and 142b providing a first opening 143 therebetween. Similarly, the outboard sidewall 152 of the second arm portion 116 comprises two wall segments 152a and 152b on other side of a second opening 153 provided therebetween. Functions of the openings 143 and 153 are described subsequently herein.

The body 112 further includes, in the example illustrated, an intermediate wall 160 extending at a 45 degree angle relative to the first and second arms 114, 116. The intermediate wall 160 can extend from an outboard wall intersection 162 (where the two outboard side edges 122 and 132 of the body 112 intersect) to an inboard wall intersection 164 (where the two inboard side edges 124 and 134 of the body 112 intersect). The intermediate wall 160 can be adapted to align with and provide support for mitered ends 92a, 94a of the first and second framing members 92, 94 (FIG. 1).

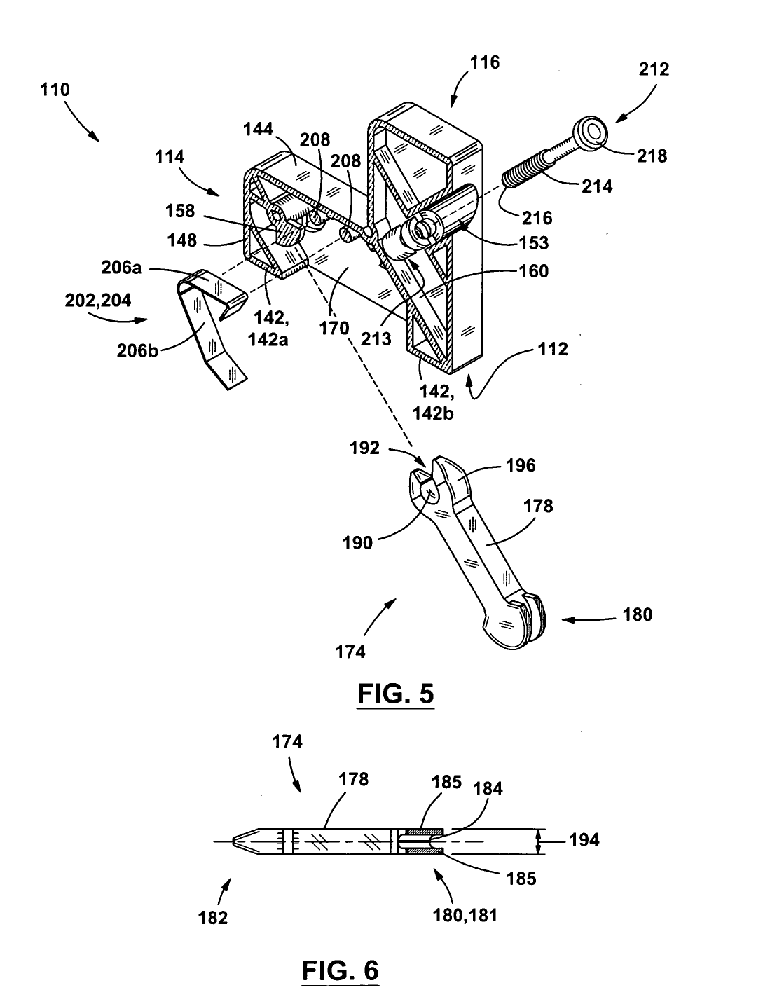

Referring now also to FIGS. 4 and 5, the body 112 defines a pocket 170 therein. In the example illustrated, the pocket 170 is disposed substantially in the first arm portion 114, and has a pocket periphery generally defined by the outboard sidewall 142, the inboard sidewall 144, the end wall 148, and the intermediate wall 160.

The corner bracket apparatus 110 further comprises a lifter member 174 pivotably coupled to the body by a pivot joint 176, and generally received in the pocket 170. The lifter member 174 can be in the form of an arm 178 having a contact portion 180 adjacent one end thereof, and a pivot connection portion 182 opposite the contact portion.

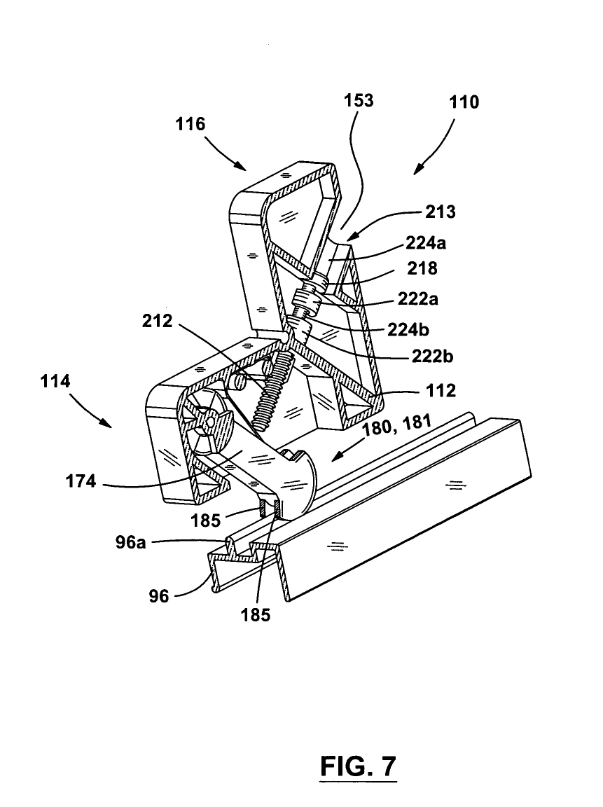

The contact portion 180 is generally adapted to bear against the runner 96 to facilitate sliding of the frame 90 therealong (see also FIG. 7). In the embodiment illustrated, the contact portion 180 is in the form of a glider 181 having an engagement surface 184 for bearing against the runner. The engagement surface 184 of the glider 181 is fixed relative to the lifter member 174, and made of a material such as a firm plastic that can readily slide over runners of various materials, including plastics or metal, with little or no risk of binding. The lifter member 174 with glider 181 can provide advantages over designs providing rollers or wheels, including reduced cost, more compact, simpler operation and reduced maintenance requirements.

In the example illustrated, the engagement surface 184 comprises a generally convex surface disposed between a pair of retaining lugs 185. The track 96 can include an upstanding rib 96a, and the engagement surface 184 can generally bear against an upper surface of the rib 96a (whether the lifter member 174 is in a partially or fully advanced position, as discussed in greater detail subsequently herein). Each retaining lug 185 can be disposed in a respective side of the rib 96a, helping to keep the engagement surface 184 properly aligned relative to the track 96.

The lifter member 174 is generally pivotable about the pivot joint 176 between an advanced position 176a (FIG. 3) in which the contact portion 180 is proud of the outboard side edge 122 of the first arm 114, and a retracted position 176b (FIG. 4) in which the contact portion 180 is generally shy of the outboard side edge 122 of the first arm 114. In the example illustrated, the first opening 143 (between wall segments 142a and 142b) accommodates passage of the lifter member 174 (or portions thereof) from the retracted to the advanced position, allowing the contact portion 180 to protrude past the outboard side edge 122.

In the example illustrated, the pivot joint 176 comprises the pivot connection portion 182 of the lifter member 174 and a pivot boss 188 fixed to the body 112 (FIG. 4). The pivot connection portion 182 can comprise a pivot aperture 190 for receiving the pivot boss 188. The pivot connection portion 182 can further comprise an attachment slot 192 extending through the thickness 194 of lifter member 174 from a peripheral surface 196 of the lifter member 174 to the pivot aperture 190 for removable snap-fit coupling between the pivot aperture 190 and the pivot boss 188. The pivot joint 176 can further comprise a retainer 198 for preventing the lifter member 174 from sliding off the pivot boss 188 along the pivot axis defined thereby. In the example illustrated, the retainer 198 comprises a retaining flange 199 extending laterally outwardly from an upper end of the pivot boss 188.

In the example illustrated, the pivot joint 176 (and pivot boss 188 thereof) is positioned inboard of the contact portion 180 of the lifter member 174. This helps to maximize the horizontal spacing between the contact portions 180 of corner brackets 110 located at opposite sides of the frame 90 (see FIG. 2), which in turn can help to inhibit rocking of the frame 90 between the upper and lower rails 96. More particularly, the first end wall 148 of the first arm portion 114 presents a distal wall of the pocket 170, and the intermediate wall 160 presents a proximate wall of the pocket 170, relative to the second arm portion 116. The pivot joint 176 is provided in the pocket 170 adjacent the distal wall 148, and the contact portion 180 of the lifter member 174 is positioned longitudinally (along a horizontal axis) between the proximate wall 160 and the pivot axis 176.

The corner bracket 110 is, in the example illustrated, further provided with biasing means 202 for urging the lifter member 174 towards the advanced position 176a. The biasing means 202 can be in the form of a leaf spring 204 comprising a strip of spring steel having two spaced-apart legs 206, namely, a fixed leg 206a and a pivot leg 206b. The fixed leg 206a can be anchored to the body 112, and the pivot leg 206b can bear against the lifter member 174, urging the lifter member 174 towards the advanced position 176a.

In the example illustrated, to facilitate assembly of the biasing means 202, the body 112 is provided with upstanding retaining bosses 208 adjacent the inboard sidewall 144 of the first arm portion 114 to retain the fixed leg 206a between the retaining bosses 208 and the inboard sidewall 144. The lifter member 174 can be urged towards the retracted position 176b by overcoming the spring force of the biasing means 202 and pivoting the lifter member 174 about the pivot joint 176, forcing the pivot leg 206b towards the fixed leg 206a, the fixed leg 206a bearing against an inner surface of the inboard sidewall 144.

Movement of the lifter member 174 to the retracted position 176b can facilitate assembly of the corner bracket apparatus into the frame 90. The lifter member 174 and biasing means 202 can be pre-assembled to the body 112. The retainer 198 can ensure that the lifter member 174 does not become separated from the pre-assembled corner bracket apparatus 110. The frame 90 can be assembled by inserting the first arm 114 of the apparatus 110 into the hollow of the first framing member 92. Upon insertion, the lifter member 174 pivots to enable passage thereof through the hollow of the framing member 92—the mitered end 92a pushes the lifter member 174 to the retracted position. Upon registration of the first opening 143 of the first arm portion of the apparatus 110 with a corresponding first opening 97a in the first framing member 92, the lifter member 174 can return to the advanced position under the influence of the biasing member 202.

The second arm portion 116 of the apparatus 110 can be inserted in the second framing member 94, so that a first corner of the frame 90 is assembled. The same procedure can be followed for the remaining three corners. The screen sheet 95 can then be secured to the members 92, 94 to complete the assembled frame 90.

After the frame 90 has been assembled, the lifter member 174 can be removed from a corresponding apparatus 110 by pulling the lifter member 174 through the registered first openings 97a, 143, separating the pivot connection portion 182 from the pivot joint 176. A new lifter member 174 can be connected to the body 112 of the apparatus 110 by inserting the pivot connection portion 182 thereof through the registered openings 97a, 143 and snap-fit assembling the pivot joint 176. The frame 90 can remain intact for replacement (and/or installation) of the lifter member 174.

The corner bracket apparatus 110 can further be provided with an adjustment member 212 for limiting the amount of retraction of the lifter member 174 relative to the body 112. The adjustment member 212 can be anchored or supported within a bore 213 provided in the body 112. The adjustment member 212 can comprise an elongate threaded element 214 having an abutment end 216 adapted to bear against the lifter member 174 to limit the retraction thereof, and an actuating end 218 opposite the abutment end 216 and accessible through the body 112 by the second opening 153 provided in the second outboard sidewall 152 of the housing adjacent the bore 213. As seen in FIG. 1, the second framing member 94 is provided with a second frame opening 97b that is aligned with the second opening 153 of the apparatus 110 in the assembled frame 90, providing access to the actuating end 218 of the adjustment member 212.

In the example illustrated, the adjustment member 212 can be selectively positioned between a withdrawn position (FIGS. 3 and 4) and a forward position (FIGS. 1 and 7). This permits a corresponding adjustment in the amount of retraction of the lifter member 174 between a maximum retraction (FIGS. 3 and 4), in which the contact portion 180 is shy of the outboard side edge 122 of the first arm 114, and a minimum retraction (FIGS. 1 and 7) in which the lifter member 174 can only be retracted partially, or in other words, is maintained at least partially towards the advanced position.

By advancing the abutment end 216 of the adjustment member 212 towards the lifter member 174, the lifter member 174 can be maintained in an at least partially advanced position, thereby taking up any excess vertical slack between the frame 90 and the opposed tracks 96. Removal of such slack can help to prevent the frame 90 from jumping or otherwise disengaging the tracks 96. As well, corner brackets 110 at the left and right sides of the frame 90 (FIG. 2) can be adjusted individually to true up the alignment of the frame 90 relative to the horizontal tracks 96 and/or relative to vertical sides (not shown) of the doorway opening against which the vertical frame members 94 may be adapted to abut.

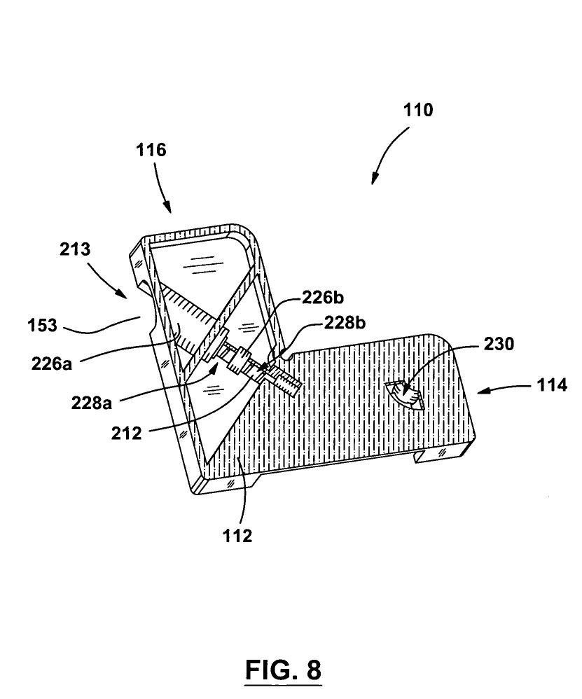

Referring to FIGS. 7 and 8, the body 112 of the apparatus 110 can advantageously be of a plastic material and can be manufactured by an injection moulding process. In the example illustrated, the body 112 is designed to facilitate injection moulding. For example, the material of the body 112 forming the bore 213 for supporting the adjustment member can be provided in staggered formation. The staggered formation includes offset semi-circular bands of material that are provided along the axial length of the bore for the adjustment member 212, wherein a band on one side of the bore is matched with a gap or void on the radial side opposite the band. In particular, on the front side (FIG. 7) of the bore 213, first and second bands 222a and 222b are provided along the bore 213. The first front band 222a is spaced apart from the opening 153 of the bore by a first front gap 224a, and the first and second front bands 222a, 222b are separated form each other by a second front gap 224b. On the rear side (FIG. 8) of the bore 213, first and second rear bands 226a, 226b are provided. The first rear band 226a generally extends axially from the opening 153 of the bore 213. First and second rear gaps are provided on axially opposite sides of the second rear band 226b. The front bands 222a, 222b are disposed generally opposite the rear gaps 228a, 228b. The rear bands 226a, 226b are disposed generally opposite the front gaps 224a, 224b.

To further facilitate manufacture by injection moulding, the body 112 has a void 230 in the shape of, and opposite of, the retaining flange 199. Furthermore, the wall thicknesses are generally uniform throughout the body 112, which can facilitate resin flow in an injection mould. As well, the various upstanding features and returns are provided in the line of draw, facilitating injection moulding with relatively simple dies that can be free of slides or lifts, thereby minimizing cost of dies and reducing cycle times for moulding operations.

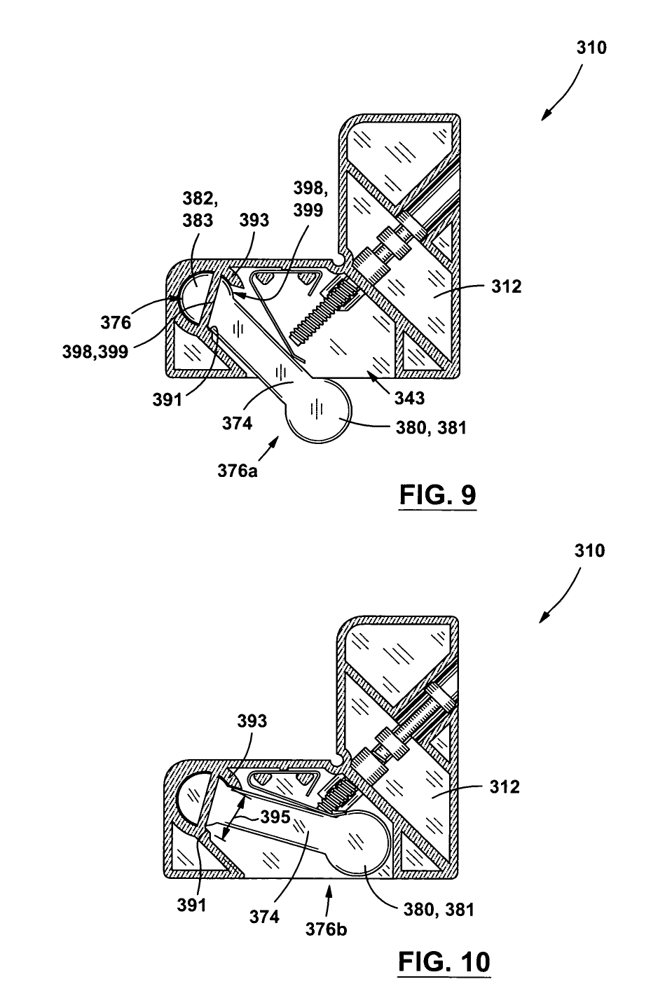

An alternative example of a corner bracket apparatus 310 can be seen in FIGS. 9 and 10. The corner bracket apparatus 310 is similar to the corner bracket apparatus 110, and like features are identified by like reference characters, incremented by 200. The corner bracket apparatus 310 has a body 312 with a lifter member 374 attached thereto at a pivot joint 376. The lifter member 374 is pivotable between an advanced position 376a (FIG. 9) and a retracted position 376b (FIG. 10). The pivot joint 376 comprises the pivot connection portion 382 of the lifter member 374 and a pivot socket 388 provided in the body 112. In the example illustrated, the pivot connection portion 382 comprises a flattened ball end 383 presenting an outer convex surface. The socket 388 is shaped to receive the ball end 383, and presents an inner concave surface to be engaged by the outer convex surface of the ball end 383.

The socket 388 has a socket opening 389 generally facing the first opening 343 of the body 312. The socket opening 389 has a width 395 extending between first and second wall segments 391, 393, respectively. The width 395 of the socket opening 389 is, in the example illustrated, narrower than the width of the ball end 383 of the lifter member 374. At least one wall segment 393 can be resiliently flexible to permit the width of the socket opening to be increased. In this way, the ball end 383 of the lifter member can be pressed through the socket opening to provide a removable snap-fit assembly of the pivot joint 376. The pivot joint 376 can further be provided with a modified retainer 398 in the form of a strap 399 extending across the top of the socket 388.

It is to be understood that what has been described are preferred examples of the teaching disclosed herein. The disclosure nonetheless is susceptible to certain changes and formation of alternative examples that remain within the scope of what is taught herein.

We claim:

1. A corner bracket apparatus for a slidable frame, comprising:
a) a body having first and second arm portions depending therefrom, the first and second arm portions being oriented generally orthogonally relative to each other and adapted for insertion into respective first and second hollow framing members of said slidable frame, the first arm defining an outboard side edge and an inboard side edge generally opposite the outboard side edge and an internal pocket positioned therebewteen;
b) a lifter member pivotably coupled to the body and generally received in the pocket, the lifter member having a contact portion adapted to bear against a runner along which said slidable frame is adapted to slide; the lifter member being pivotable between an advanced position in which the contact portion is proud of the outboard side edge of the first arm, and a retracted position in which the contact portion is generally shy of the outboard side edge of the first arm; and
c) biasing means for urging the lifter member towards the advanced position.

2. The apparatus of claim 1 comprising an adjustment member for adjusting the retracted position of the lifter member relative to the body, the retracted position adjustable between a maximum retraction in which the contact portion is shy of the outboard side edge of the first arm, and a minimum retraction position in which the lifter member is disposed at least partially towards the advanced position.

3. The apparatus of claim 2 wherein the adjustment member comprises an elongate threaded element having an abutment end engaged by the lifter member when in the retracted position and an actuating end opposite the abutment end and accessible through the housing by a second opening provided in a second sidewall of the housing.

4. The apparatus of claim 1 wherein the body comprises a pivot boss, and the lifter member comprises a pivot aperture for pivotal engagement with the pivot boss.

5. The apparatus of claim 4 wherein the body and pivot boss are of integrally moulded construction.

6. The apparatus of claim 4 wherein the lifter member comprises an attachment slot extending through the thickness of lifter member from an outer surface of the lifter member to the pivot aperture for removable snap-fit coupling between the pivot aperture of the lifter member and the pivot boss.

7. The apparatus of claim 6 wherein the first opening has a thickness that is greater than the thickness of the lifter member such that the lifter member can pass through the first opening for the removable snap-fit coupling between the pivot aperture of the lifter member and the pivot boss.

8. The apparatus of claim 6 wherein the pocket is provided substantially in the first arm and extends longitudinally between a proximate sidewall near the second arm and a distal sidewall spaced away from the second arm, and wherein the pivot boss is provided in the pocket adjacent the distal sidewall such that the contact portion is positioned longitudinally intermediate the pivot boss and the proximate sidewall.

9. The apparatus of claim 1 wherein the biasing means comprises a leaf spring having a first leg bearing against an inner surface of the pocket and a second leg bearing against the lifter member.

10. The apparatus of claim 1 wherein the contact portion comprises a glider element.

11. The apparatus of claim 10 wherein the glider element comprises a concave surface that is stationary relative to the lifter member and adapted to bear against an upper surface of the runner.

12. The apparatus of claim 10 wherein the glider element comprises retaining lugs on either side of the concave surface, the retaining lugs adapted to engage respective opposing side surfaces of the runner.

13. A corner bracket apparatus for a slidable frame, comprising:
a) a body having first and second arm portions depending therefrom, the first and second arm portions being oriented generally orthogonally relative to each other and adapted for insertion into respective first and second hollow framing members of said slidable frame, the first arm defining an outboard side edge and an inboard side edge generally opposite the outboard side edge and an internal pocket positioned therebewteen;
b) a lifter member pivotably coupled to the body and generally received in the pocket, the lifter member having a contact portion adapted to bear against a runner along which said slidable frame is adapted to slide, the contact portion being fixed relative to the lifter member, the lifter member being pivotable between an advanced position in which the contact portion is proud of the outboard side edge of the first arm, and a retracted position in which the contact portion is generally shy of the outboard side edge of the first arm; and
c) biasing means for urging the lifter member towards the advanced position.

14. The apparatus of claim 13 comprising a pivot joint for coupling the lifter member to the body, the pivot joint comprising a socket provided in the body and a flattened ball portion of the lifter member disposed opposite the contact portion, the ball portion retained in the socket and adapted to pivot therein.

15. The apparatus of claim 13 wherein the body is of integrally moulded construction.
